(19) United States
(12) Patent Application Publication
(10) Pub. No.: US 2025/0053551 A1
(43) Pub. Date: Feb. 13, 2025

(54) TECHNIQUES FOR TRANSITIONING DATABASE TABLES FROM PRODUCTION TO NON-PRODUCTION ENVIRONMENTS

(71) Applicant: Insight Direct USA, Inc., Chandler, AZ (US)

(72) Inventor: Abhijit Moharil, Tempe, AZ (US)

(21) Appl. No.: 18/232,482

(22) Filed: Aug. 10, 2023

(51) Int. Cl. G06F 16/22; G06F 16/25

(52) U.S. Cl. CPC G06F 16/2282; G06F 16/258

(57) ABSTRACT

A name conversion system includes computer-readable memory encoded with instructions that, when executed by one or more processors, cause the name conversion system to make name changes identified in a list of name conversions to tables of data by identifying name changes for records in the tables in a database, identifying each table in the database, determining whether each table has an index, searching a column of a table designated in the index and changing one or more names of records in the column as identified in the list of name conversions so that any column not included in the index is not searched when the table has an index, and searching an entirety of a table and changing one or more names of records in the table as identified in the list of name conversions when the table does not have an index.

### BACKGROUND

The present disclosure relates to data conversion, and in particular, to a name conversion system for data.

Non-production databases may include testing databases. When changes need to be made to a production database, they are first tested in a testing database. Prior to implementing a change, such as an update, in the production database, the change undergoes quality assurance testing in a quality assurance testing database. Whether the change works, or yields the proper result without breaking, or causing unwanted change to, other parts of the quality assurance testing database, indicates whether the change passes quality assurance testing. The change can be implemented into the production database if it passes the quality assurance testing. In order to accurately test changes in the quality assurance testing database, the quality assurance testing database must comprise data similar to the data in the production database. Data can be transferred from the production database to the quality assurance testing database. In the quality assurance testing database, data may need to be converted to differentiate it from the data in the production database.

### SUMMARY

A name conversion system includes a first database for storing raw data, a second database for storing converted data, one or more processors, and computer-readable memory. The computer-readable memory is encoded with instructions that, when executed by the one or more processors, cause the name conversion system to access raw data from the first database, copy the raw data from the first database to the second database, access a list of name conversions, make name changes identified in the list of name conversions to tables of data that has been copied to the second database to complete name conversions, and store converted data comprising the data that has been copied to the second database and has undergone name changes and non-converted data comprising the data that has been copied to the second database and has not undergone name changes in the second database for access via a user interface. Name changes identified in the list of name conversions are made to tables of data that has been copied to the second database to complete name conversions by identifying name changes for records in the tables in the second database, identifying each table of the tables in the second database, determining whether each table has an index, searching a column of a table designated in the index and changing one or more names of records in the column as identified in the list of name conversions so that any column not included in the index is not searched when the table has an index, and searching an entirety of a table and changing one or more names of records in the table as identified in the list of name conversions when the table does not have an index.

A method of converting names for a non-production database includes accessing raw data from a production database, copying the raw data from the production database to a non-production database, accessing a list of name conversions, making name changes identified in the list of name conversions to tables of data that has been copied to the non-production database to complete name conversions, and storing converted data and non-converted data in the non-production database for access via a user interface. Name changes identified in the list of name conversions are made to tables of data that has been copied to the non-production database to complete name conversions by identifying name changes for records in the tables in the non-production database, identifying each table of the tables in the non-production database, determining whether each table has an index, searching a column of a table designated in the index and changing one or more names of records in the column as identified in the list of name conversions so that any column not included in the index is not searched when the table has an index, and searching an entirety of a table and changing one or more names of records in the table as identified in the list of name conversions when the table does not have an index.

### BRIEF DESCRIPTION OF THE DRAWINGS

FIG. 1 is a schematic diagram showing a name conversion system for converting names of records from a production database in a non-production database.

FIG. 2 is a schematic block diagram showing a name conversion server of the name conversion system.

FIG. 3 is a flowchart illustrating steps of a process for converting names of records using the name conversion system.

FIG. 4 is a flowchart illustrating steps for executing a step of the process of FIG. 3 to make name changes to complete name conversions.

### DETAILED DESCRIPTION

In general, the present disclosure describes a name conversion system for a non-production database that copies raw data from a production database to the non-production database, which has the same structure as the production database at a certain point in time to allow for quality assurance testing or testing of database changes without affecting the active data of the production database. Name changes from a list of name conversions are made to records in tables of the raw data copied to the non-production database. Indices identify columns in the tables of the raw data in which the records requiring name changes are stored. Only the indexed columns of the tables with an index, along with the entirety of the tables without an index, are searched for changing names, saving computation time and bandwidth.

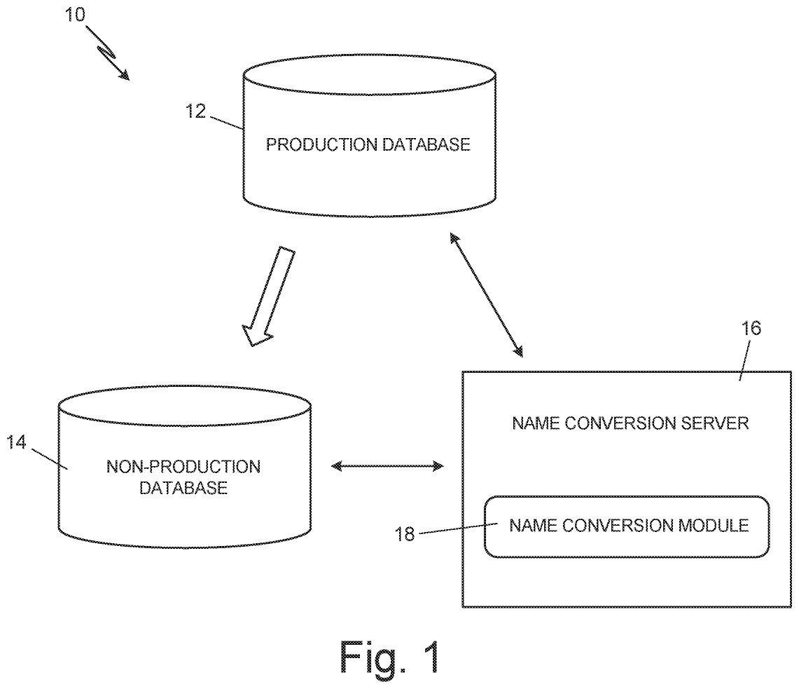

FIG. 1 is a schematic diagram showing name conversion system 10 for converting names of records from production database 12 in non-production database 14. Name conversion system 10 includes production database 12, non-production database 14, and name conversion server 16, which includes name conversion module 18.

Production database 12 contains raw data, or active data. Raw data has not undergone any changes. In production database 12, data is stored in tables made up of rows and columns. The intersection of a row and column within a table is a field. As such, each table contains fields of data. Each field includes a single record of data. Some tables of data in production database 12 contain a large number of records. The records of data within production database 12 each have a name. Names of records of data within production database 12 may include a name that references and potentially interacts with production database 12.

Non-production database 14 is a database similar to production database 12. For example, non-production database 14 has a similar configuration to production database 12. Non-production database 14 may be a quality assurance testing database or any other suitable non-production database. Non-production database 14 contains copied data from production database 12. Non-production database 14 is in communication with name conversion server 16. Non-production database 14 may be in the cloud or may be stored in any suitable environment accessible by name conversion server 16, such as within name conversion server 16. In non-production database 14, data is stored in tables made up of rows and columns. The intersection of a row and column within a table is a field. As such, each table contains fields of data, similar to production database 12. Each field includes a single record of data. Some tables of data in non-production database 14 contain a large number of records. The records of data within non-production database 14 each have a name. When data is copied from production database 12 to non-production database 14, the names of records of data within non-production database 14 have the same name as the names of records of data within production database 12. The names of records within non-production database 14 can be changed after data has been copied to non-production database 14. Non-production database 14 is accessible by users via name conversion server 16. Changes made to data within non-production database 14 need to remain in non-production database 14.

Name conversion server 16 is a server on which name conversion module 18 is running. Name conversion server 16 is in communication with production database 12 and non-production database 14. Name conversion module 18 interacts with production database 12 and non-production database 14 via name conversion server 16. Name conversion module 18 accesses and copies data from production database 12 to non-production database 14. Once the data from production database 12 is copied to non-production database 14, name conversion module 18 runs a script that converts, or changes, the names of records of the data in non-production database 14 that reference and interact with production database 14. Records that have undergone name conversions are converted data. The names of records of the data that do not reference and do not interact with production database 12 do not require name changes. Records that have been copied to non-production database 14 but have not undergone name conversions are non-converted data. The modified data, comprising both converted data and non-converted data copied from production database 12, is stored in non-production database 14 for use within non-production database 14.

Production database 12 may require a change, or build, such an update. A change that is going to be implemented in production database 12 needs to first be tested in non-production database 14, such as a quality assurance testing database. When the requisite change is developed, such as an SAP transport or SAP build, the change undergoes quality assurance testing in non-production database 14. The functionality of the change is tested in non-production database 14 to determine whether to promote the change to production database 12 for use in production database 12. For example, users of non-production database 14 can run quality assurance testing scripts or queries to see whether the change yields the proper result without causing unwanted change to non-production database 14. Changes are promoted to production database 12 if they pass quality assurance testing in non-production database 14. If changes do not pass quality assurance testing in non-production database 14, they are not implemented into production database 12. Because non-production database 14 is similar to production database 12, non-production database 14 serves as an accurate test environment as it simulates production database 12. As such, if the change to non-production database 14 is functional and accurate, or yields the proper results without disrupting other functionalities of non-production database 14, the change will be functional and accurate in production database 12. Thus, the change will accurately pass quality assurance testing.

Because raw data from production database 12 is copied to non-production database 14, modified data in non-production database 14 is similar to the data in production database 12, allowing for more accurate quality assurance testing. As names of records of data within production database 12 may reference and interact with production database 12, some records require name changes after being copied to non-production database 14. Name conversion module 18 changes the names of such records of the data in non-production database 14 so that when quality assurance testing changes are made in non-production database 14, the changes are not propagated to production database 12. As such, changes to non-production database 14, including those that do not pass quality assurance testing, do not get inadvertently promoted to production database 12. As a result, name conversion system 10 protects the active data within production database 12 by preventing unwanted changes to production database 12 that would corrupt the original raw data within production database 12. At the same time, name conversion module 18 still provides near identical data for users of non-production database 14 to accurately perform quality assurance testing.

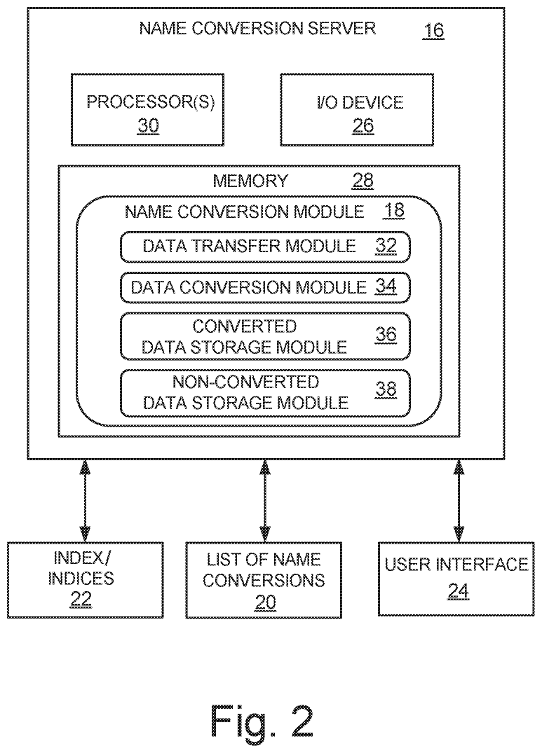

FIG. 2 is a schematic block diagram showing name conversion server 16 of name conversion system 10. Name conversion server 16 interacts with list of name conversions 20, index/indices 22, and user interface 24 to provide modified data to a user. Name conversion server 16 includes I/O device 26, memory 28, and processor(s) 30. Memory 28 includes name conversion module 18, which includes data transfer module 32, data conversion module 34, converted data storage module 36, and non-converted data storage module 38.

Non-production database 14, shown in FIG. 1, contains modified data from production database 12, including non-converted data that has not undergone name conversions and converted data that has undergone name conversions. Name conversion module 18 on name conversion server 16 converts the names of records of the data in non-production database 14 to yield converted data. Name conversion module 18 determines which names of records of the data to change based on list of name conversions 20. List of name conversions 20 contains instructions in code regarding which names of records of the data in non-production database 14 to change and the new names with which to replace the names of records of the data. For example, list of name conversions 20 can comprise instructions to change the names of records of the data having “ECP” in the name to names having “ECQ” in place of “ECP.” In this example, the “P” in “ECP” references production database 12, and the “Q” in “ECQ” references quality assurance testing non-production database 14. List of name conversions 20 instructs name conversion module 18 to search through all the tables of the data in non-production database 14 to make the name changes identified on list of name conversions 20.

Prior to searching through an identified table, name conversion module 18 checks index/indices 22. Index/indices 22 may include one index 22 or a plurality of indices 22. For example, name conversion system 10 may include 84 different indices 22, some tables of the data of non-production database 14 having more than one associated index 22. Indices 22 are generated for tables containing a large number of records, such as a table including several thousand records that require name conversions. For example, a table of data may contain 87 million records, with 20,000 of those records requiring name conversions. For the tables containing a large number of records, indices 22 are included to identify the column(s) within each table to search, that column(s) containing the records having names that require changes. More specifically, indices 22 contain instructions in code regarding which column(s) of a table to search. As such, each index 22 identifies a table name and a name of a column within that table that contains records requiring name conversions. For example, index 22 may include table name “030” and indicate that the column “LOGSYS” within table “030” should be searched. Name conversion module 18 determines whether an identified table corresponds to index 22. If the table has one or more indices 22, name conversion module 18 searches only the one or more columns of that table listed in the one or more indices 22. Smaller tables containing a few records, such as 10 or fewer, may not have index 22 as little time is required to search the entire table.

The modified data, including the converted data that was converted by name conversion module 18 and the non-converted data, is accessible via user interface 24. User interface 24 allows users of non-production database 14 to interact with the modified data via name conversion server 16. User interface 24 can include control elements that enable user interaction with name conversion server 16 and non-production database 14. User interface 24 can include a display to present the modified data in non-production database 14 to a user. The display can be a liquid crystal display (LCD), a light-emitting diode (LED) display, an organic light-emitting diode (OLED) display, or other display device suitable for providing information to users. User interface 24 can include physical control elements that enable user input to interact with name conversion server 16 and/or non-production database 14.

I/O device 26 of name conversion server 16 can communicate wirelessly with various peripheral devices, such as user interface 24. I/O device 26 can include a plurality of input and/or output (I/O) connectors configured for wired connection (e.g., electrical and/or communicative connection) with one or more components of name conversion server 16 and non-production database 14. I/O device 26 can include any number of I/O connectors.

Memory 28 is configured to store information, including instructions and software code to be executed by processor(s) 30. Memory 28 can be described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). Memory 28 can include volatile and non-volatile computer-readable memories. Examples of volatile memories can include random access memories (RAM), dynamic random-access memories (DRAM), static random-access memories (SRAM), and other forms of volatile memories. Examples of non-volatile memories can include, e.g., magnetic hard discs, optical discs, flash memories, or forms of electrically programmable memories (EPROM) or electrically erasable and programmable (EEPROM) memories.

Processor(s) 30 is capable of processing instructions stored in memory 28. Processor(s) 30 is configured to execute instructions, such as software code that implements modules of name conversion module 18, which produces converted data and non-converted data for use by users of non-production database 14. Examples of processor 30 can include any one or more of a microprocessor, a controller, a digital signal processor (DSP), an application specific integrated circuit (ASIC), a field-programmable gate array (FPGA), or other equivalent discrete or integrated logic circuitry.

Name conversion module 18 stored in memory 28 includes data transfer module 32, data conversion module 34, converted data storage module 36, and non-converted data storage module 38. Although described herein as being divided into four modules, the functionality of data transfer module 32, data conversion module 34, converted data storage module 36, and non-converted data storage module 38 could also be more or fewer modules, which could depend on how the code is written or organized.

Data transfer module 32 is a first module of name conversion module 18. Data transfer module 32 includes methods in code for accessing the raw data from production database 12 and copying the raw data from production database 12 to non-production database 14.

Data conversion module 34 is a second module of name conversion module 18. Data conversion module 34 includes methods in code for finding the names of records of the data in non-production database 14 that require conversion and for changing the names that have been identified. List of name conversions 20 and indices 22 are used to find the names of records of the data in non-production database 14 that require conversion. List of name conversions 20 is used to identify the names of records of the data to change and to identify the new names with which to replace the names requiring conversion. During name conversion, a script of data conversion module 34 changes the names of identified records of data within tables in non-production database 14. The names of records of data are changed by replacing the name of each identified record of data with a designated new name from list of name conversions 20. The new name does not interact with production database 12. The new name may interact with non-production database 14, such as a quality assurance testing database.

Converted data storage module 36 is a third module of name conversion module 18. Converted data storage module 36 includes methods in code for storing converted data in non-production database 14 for access via user interface 24. The converted data is stored in the tables containing modified data.

Non-converted data storage module 38 is a fourth module of name conversion module 18. Non-converted data storage module 38 includes methods in code for storing non-converted data in non-production database 14 for access via user interface 24. The non-converted data is stored along with the converted data in the tables containing modified data.

Name conversion module 18 can identify and make changes to designated names of records of the data in non-production database 14 so that changes can be made to non-production database 14 without risk of the changes being inadvertently propagated to production database 12. By using indices 22 to identify the columns in which the name changes are needed, all columns within the tables of data of non-production database 14 do not need to be searched. As a result, indices 22 greatly decrease the amount of time required to complete name conversions for large tables of data.

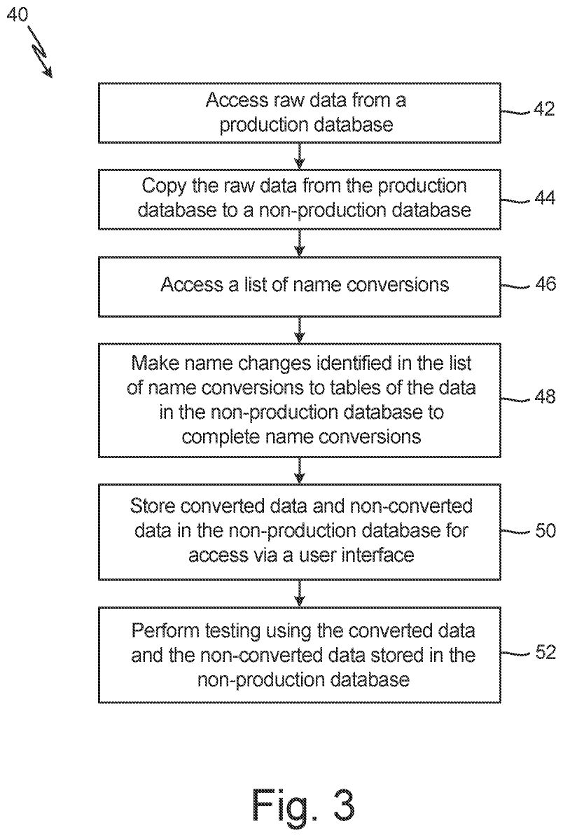

FIG. 3 is a flowchart illustrating steps 42-52 of process 40 for converting names of records using name conversion system 10. Process 40 includes step 42, step 44, step 46, step 48, step 50, and step 52.

Step 42 is a first step of process 40. At step 42, name conversion server 16 accesses raw data from production database 12. Data transfer module 32 of name conversion module 18 accesses raw data, which is active data, from production database 12. The raw data includes record names that reference and may interact with production database 12 and record names that do not reference or do not interact with production database 12.

Step 44 is a second step of process 40. At step 44, name conversion server 16 copies all raw data from production database 12 to non-production database 14. Data transfer module 32 of name conversion module 18 copies the raw data that has been accessed in production database 12 to non-production database 14. When raw data is copied to non-production database 14, the data within non-production database 14 is identical to the data in production database 12.

Step 46 is a third step of process 40. At step 46, name conversion server 16 accesses list of name conversions 20. Data conversion module 34 of name conversion module 18 accesses list of name conversions 20, which will identify name changes for records of the data in non-production database 14.

Step 48 is a fourth step of process 40. At step 48, name conversion server 16 makes name changes identified in list of name conversions 20 to tables of the data in non-production database 14 to complete name conversions. Data conversion module 34 identifies name changes for records in the tables of the data in non-production database 14 via list of name conversions 20. Data conversion module 34 searches through non-production database 14 to identify each of the tables within non-production database 14. Data conversion module 34 checks indices 22 prior to searching through an identified table. If one or more indices 22 correspond to that table, data conversion module 34 searches only the column(s) of that table identified in one more or indices 22. Data conversion module 32 makes name changes identified in list of name conversions 20 to records within those column(s). As such, the name that references production database 12 is replaced with a name from list of name conversions 20 that does not reference production database 12. If the table does not correspond to index 22, data conversion module 34 searches through the entirety of the table to make name changes identified in list of name conversions 20 to records within the table. Data conversion module 32 may search tables of the data in non-production database 14 in parallel. When data conversion module 34 has searched each identified table and made all identified name changes, non-production database 14 no longer contains records of data having names that reference and may interact with production database 12.

Step 50 is a fifth step of process 40. At step 50, name conversion server 16 stores converted data and non-converted data in non-production database 14 for access via user interface 24. Converted data storage module 36 of name conversion module 18 stores the records that have undergone name conversions in non-production database 14. Non-converted data storage module 38 of name conversion module 18 stores the records that have been copied from production database 12, but have not undergone name conversions, in non-production database 14. Copied data within non-production database 14 is modified data. Modified data includes the converted data comprising records that have undergone name conversions and the non-converted data that comprises records that have not undergone name conversions. The modified data in non-production database 14 can be accessed through name conversion server 16 via user interface 24.

Step 52 is a sixth step of process 40. At step 52, testing is performed on the converted data and the non-converted data stored in non-production database 14. Testing is performed based upon signals from user interface 24. For example, a user of non-production database 14 can input a test query on user interface 24. The resulting table(s) of data from the query can include converted data and non-converted data from non-production database 14.

Name conversion system 10 using process 40 for converting names of records allows records of data having names that reference and may interact with production database 12 to be converted for use in non-production database 14 in a short amount of time. When non-production database 14 is used, such as for quality assurance testing, non-production database 14 does not contain records of data having names that reference and may interact with production database 12. As such, non-production database 14 is ready for use sooner and changes made to non-production database 14 are not at risk of being propagated to production database 12.

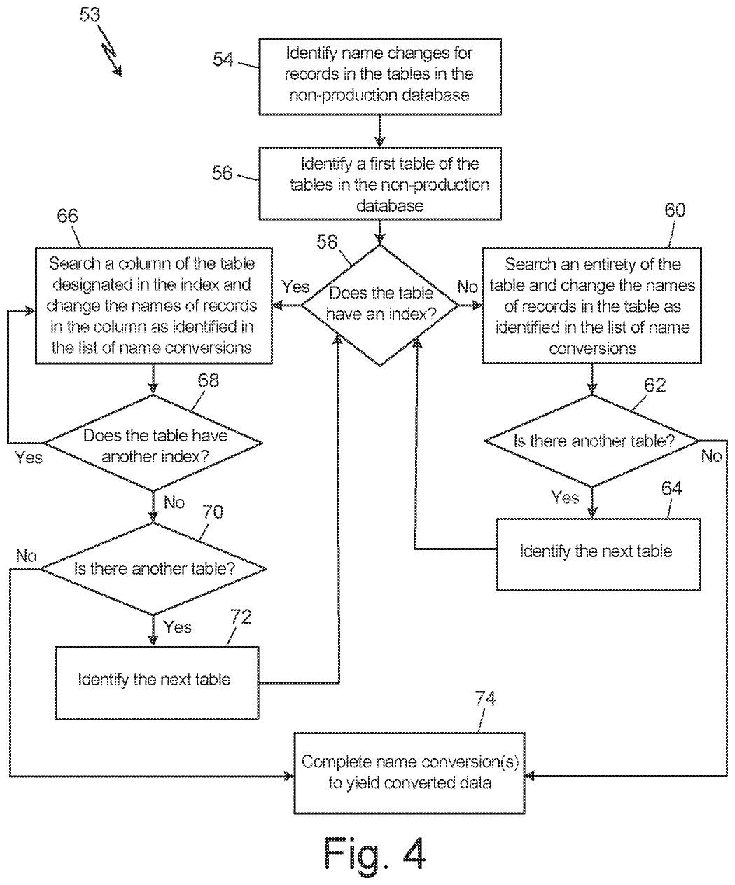

FIG. 4 is a flowchart illustrating steps 54-74 of process 53 for executing step 48 of process 40 of FIG. 3 to make name changes to complete name conversions. Process 53 includes step 54, step 56, step 58, step 60, step 62, step 64, step 66, step 68, step 70, and step 72, and step 74.

Step 54 is a first step of process 53. At step 54, name conversion server 16 identifies names changes for records in the tables of data in non-production database 14. Data conversion module 34 of name conversion server 16 identifies which name changes to make for records in the tables in non-production database 14 via list of name conversions 20.

Step 56 is a second step of process 53. At step 56, name conversion server 16 identifies a first table of the tables in non-production database 14. Data conversion module 34 of name conversion server 16 begins a search of non-production database 14, identifying the name of a first table of the tables in non-production database 14 to start of the search.

Step 58 is a third step of process 53. At step 58, name conversion server 16 determines whether the table has an index. Data conversion module 34 of name conversion server 16 checks indices 22 to determine if the identified table corresponds to one of indices 22. Data conversion module 34 scans through indices 22 to discover whether the name of the table is in one of indices 22. If not, the table does not have index 22, and process 53 proceeds to step 60. If so, the table does have index 22, which has been identified, and process 53 proceeds to step 66.

At step 60 of process 53, name conversion server 16 searches an entirety of the table and changes the names of records in the table as identified in list of name conversions 20. Data conversion module 34 of name conversion server 16 searches all records of all columns of the table to determine if a name change is required for each of the records, as identified in list of name conversions 20. If a record having a name identified in list of name conversions 20 is found, data conversion module 34 changes the name of the record by replacing the name of the record, which references and may interact with production database 12, with the new name identified in list of name conversions 20. The new name does not reference or interact with production database 12. For some tables, no changes may be required for any of the records in the table. Alternatively, one or more records in the table may undergo a name conversion by data conversion module 34. Process 53 proceeds to step 62.

At step 62 of process 53, name conversion server 16 determines whether there is another table in non-production database 14. Data conversion module 34 of name conversion server 16 searches non-production database 14 for another table. If there is another table in non-production database 14, process 53 proceeds to step 64. If there is not another table in non-production database 14, process 53 proceeds to step 74.

At step 64 of process 53, name conversion server 16 identifies the next table of the tables in non-production database 14. Data conversion module 34 of name conversion server 16 continues the search of non-production database 14, identifying the name of the table found in step 62. Next, process 53 repeats step 58 for the identified table.

At step 66 of process 53, name conversion server 16 searches a column of the table designated in index 22 and changes the names of records in the column as identified in list of name conversions 20. Data conversion module 34 of name conversion server 16 searches only the column designated in index 22. Data conversion module 34 scans the records in that column of the table to determine if a name change is required for each of the records, as identified in list of name conversions 20. If a record having a name identified in list of name conversions 20 is found in the column, data conversion module 34 changes the name of the record by replacing the name of the record, which references and may interact with production database 12, with the new name identified in list of name conversions 20. The new name does not reference or interact with production database 12. One or more records in the column may undergo a name conversion by data conversion module 34. Once the column designated in index 22 has been searched to make name changes of records in the column, process 53 proceeds to step 68.

At step 68 of process 53, name conversion server 16 determines whether the table has another index. Data conversion module 34 of name conversion server 16 checks indices 22 to determine if the identified table corresponds to another of indices 22. Data conversion module 34 scans through indices 22 to discover whether the name of the table is in another of indices 22. If so, the table does have another index 22, which has been identified, and process 53 repeats step 66 for the identified index. If not, the table does not have another index 22, and process 53 proceeds to step 70.

At step 70 of process 53, name conversion server 16 determines whether there is another table. Data conversion module 34 of name conversion server 16 searches non-production database 14 for another table that has not been searched. If there is another table in non-production database 14, process 53 proceeds to step 72. If there is not another table in non-production database 14, process 53 proceeds to step 74.

At step 72 of process 53, name conversion server 16 identifies the next table. Data conversion module 34 of name conversion server 16 continues the search of non-production database 14, identifying the name of the table found in step 70. Next, process 53 repeats step 58 for the identified table.

Step 74 is a final step of process 53. At step 74, name conversion server 16 completes name conversions to yield converted data. Each of the tables within non-production database 14 has been identified by data conversion module 34, which has also made all name changes identified in list of name conversions 20, bringing the name conversion process to completion. As a result, all records of the data within non-production database 14 that had names referencing and tying back to production database 12 are converted data. Process 53 is completed, completing step 48 of process 40. Non-production database 14 is ready for step 50 of process 40.

The entirety of production database 12 is copied to non-production database 14. Not all tables or columns within tables have record names that reference and may interact with production database 12. Thus, not all tables or columns with tables have data that requires name conversions. Because indices 22 identify the column(s) within an identified table that includes the records requiring name conversions, name conversion server 16 can go directly to the identified column(s) to scan the records of the column(s) and make name changes. The rest of the table does not need to be searched, expediting the conversion process. For example, indices 22 can decrease the amount of time required for the name conversion process from several days to a few hours. As such, a change could be tested in non-production database 14 and promoted to production database 12 the same day that non-production database 12 is updated. As a result, non-production database 14 is ready for use much sooner, improving performance when a refresh of non-production database 14 is needed.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A name conversion system comprising:
a first database for storing raw data;
a second database for storing converted data;
one or more processors; and
computer-readable memory encoded with instructions that, when executed by the one or more processors, cause the name conversion system to:
access raw data from the first database;
copy the raw data from the first database to the second database;
access a list of name conversions;
make name changes identified in the list of name conversions in parallel to tables of data that has been copied to the second database to complete name conversions by performing steps (a)-(e) to more than one table of data that has been copied to the second database in parallel, wherein:
(a) comprises identifying name changes for records in the tables in the second database;
(b) comprises identifying each table of the tables in the second database;
(c) comprises determining indices associated with the tables;
(d) comprises searching tables associated with the indices, wherein the searching comprises:
searching a column of a respective table designated in the associated index and changing one or more names of records in the column as identified in the list of name conversions so that any column not included in the index is not searched when the table has an index; and
(e) comprises searching an entirety of a table and changing one or more names of records in the table as identified in the list of name conversions when the table is not associated with an index; and
store converted data comprising the data that has been copied to the second database and has undergone name changes and non-converted data comprising the data that has been copied to the second database and has not undergone name changes in the second database for access via a user interface.

2. The system of claim 1, wherein the first database is a production database, and the second database is a non-production database.

3. The system of claim 2, wherein the non-production database is a quality assurance testing database.

4. The system of claim 1, wherein the computer-readable memory is encoded with instructions that, when executed by the one or more processors, causes the name conversion system to perform testing using the converted data and the non-converted data stored in the second database.

5. The system of claim 1, wherein a table of the tables in the second database has more than one index.

6. The system of claim 1, wherein the one or more names of records in the column reference the first database.

7. The system of claim 6, wherein the one or more names of records in the column are changed to one or more names that reference the second database.

8. The system of claim 1, wherein the one or more names of records in the table reference the first database.

9. The system of claim 8, wherein the one or more names of records in the table are changed to one or more names that reference the second database.

10. A method of converting names for a non-production database, the method comprising:
accessing raw data from a production database;
copying the raw data from the production database to a non-production database;
accessing a list of name conversions;
making name changes identified in the list of name conversions in parallel to tables of data that has been copied to the non-production database to complete name conversions by performing steps (a)-(e) to more than one table of data that has been copied to the non-production database in parallel, wherein:
(a) comprises identifying name changes for records in the tables in the non-production database;
(b) comprises identifying each table of the tables in the non-production database;
(c) comprises determining indices associated with the tables;
(d) comprises searching tables associated with the indices, wherein the searching comprises:
searching a column of a respective table designated in the associated index and changing one or more names of records in the column as identified in the list of name conversions so that any column not included in the index is not searched when the table has an index; and
(e) comprises searching an entirety of a table and changing one or more names of records in the table as identified in the list of name conversions when the table is not associated with an index; and
storing converted data and non-converted data in the non-production database for access via a user interface.

11. The method of claim 10, further comprising performing testing using the converted data and the non-converted data stored in the non-production database.

12. The method of claim 10, wherein the converted data comprises the data that has been copied to the second database and has undergone name changes, and the non-converted data comprising the data that has been copied to the second database and has not undergone name changes.

13. The method of claim 10, wherein the non-production database is a quality assurance testing database.

14. The method of claim 10, wherein the one or more names of records in the column reference the production database.

15. The method of claim 14, wherein the one or more names of records in the column are changed to one or more names that reference the non-production database.

16. The method of claim 10, wherein the one or more names of records in the table reference the production database.

17. The method of claim 16, wherein the one or more names of records in the table are changed to one or more names that reference the non-production database.

18. The method of claim 10, wherein a table of the tables in the non-production database has more than one index.

19. A method for modifying data in a non-production database prior to promoting the data in the non-production database to a production database, the method comprising:
accessing raw data from the production database;
copying the raw data from the production database to the non-production database;
accessing a list of name conversions;
making name changes identified in the list of name conversions in parallel to tables of data that has been copied to the non-production database to complete name conversions by performing steps (a)-(e) to more than one table of data that has been copied to the non-production database in parallel, wherein:
(a) comprises identifying name changes for records in the tables in the non-production database;
(b) comprises identifying each table of the tables in the non-production database;
(c) comprises determining indices associated with the tables;
(d) comprises searching tables associated with the indices, wherein the searching comprises:
searching a column of a respective table designated in the associated index and changing one or more names of records in the column as identified in the list of name conversions so that any column not included in the index is not searched when the table has an index; and
(e) comprises searching an entirety of a table and changing one or more names of records in the table as identified in the list of name conversions when the table is not associated with an index; and
storing converted data and non-converted data in the non-production database for access via a user interface.

20. The method of claim 19, wherein the one or more names of records in the column reference the production database, and the one or more names of records in the column are changed to one or more names that reference the non-production database.
